(19) United States
(12) Patent Application Publication
(10) Pub. No.: US 2008/0098420 A1
(43) Pub. Date: Apr. 24, 2008

(54) Distribution and display of advertising for devices in a network

(75) Inventors: Amit Khivesara, Clifton, NJ (US); Howard Lee, Redwood City, CA (US); Peter Andrew Mataga, Sparta, NJ (US); Cary Torkelson, Allendale, NJ (US); Vinod Valloppillil, San Francisco, CA (US); Edgar Villanueva, Rockaway, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Roundbox, Inc., Forham Park, NJ (US)

(21) Appl. No.: 11/643,721

(22) Filed: Dec. 20, 2006

Related U.S. Application Data
(60) Provisional application No. 60/862,117, filed on Oct. 19, 2006.

(51) Int. Cl. H04N 7/10

(52) U.S. Cl. 725/32

(57) ABSTRACT

A system and associated apparatus and methods for the distribution, selection and display of advertising content for devices operating in a network. The devices need not initiate a point-to-point communication with an ad server to provide the ability to filter received advertising content and enable the display of advertisements that are targeted to a device's user. The invention enables a service provider or network operator to control the policy used to specify the selection, timing, and display of an advertisement stored in a cache of a client device. A modification to the policy can be broadcast and implemented in real-time by the device. Advertisements stored in the cache may be filtered both by the service provider or network operator and by the device itself so as to provide the best selection of ads tailored to the user of the device. The device implements cache management processes to determine how best to maintain the advertisements of greatest relevance to the user of the device. The invention also provides mechanisms for the reporting of statistics that can be used for billing purposes and to better filter the selection of advertisements cached at each device.

### CROSS-REFERENCE TO RELATED APPLICATIONS

This application is related to and claims the benefit of U.S. provisional patent application No. 60/862,117, entitled “Distribution And Display Of Advertising”, filed Oct. 19, 2006, the contents of which is incorporated by reference.

### BACKGROUND OF THE INVENTION

The present invention is directed to systems, apparatus, and methods for the distribution and display of advertising content on a client device, and more specifically, to the distribution and display of such content in environments where the devices receiving the advertisements need not necessarily initiate point-to-point communication with the broadcast agency to provide the ability to filter received advertisements so that advertisements relevant or specifically targeted to the device's user are displayed. This is particularly applicable to the broadcast of advertisements in a wireless network where addressing each device can be prohibitively expensive or technically not feasible due to network bandwidth limitations, although it is understood that the systems, apparatus, and methods discussed may be applicable to mobile and other devices as well, and may be implemented in such a manner as to involve data transmission over either a wired or wireless network.

As mobile and other forms of telecommunications services have increased in type and availability, there has been a related increase in the desire to facilitate commerce and other types of transactions using mobile devices, such as mobile wireless phones, PDAs, and wireless-network connected laptop computers, as well as ATMs, kiosks, and other types of devices. As with other forms of communication that may be used for commerce, mobile and other devices provide a platform for the delivery of advertising content, with the intention of stimulating commerce transactions by delivery and timely presentation of that advertising content.

In order to effectively deliver and present advertising content, it is important that certain characteristics of the process be considered so that the design of the overall system for delivering that content takes into account the relevant factors or parameters of the process. These characteristics include, for example, the content type (audio, visual, multi-media, text, etc.), the intended recipient and relevant characteristics of that recipient, the delivery channel, the device on which the advertising is to be displayed, and the current usage of the device, such as which applications are running or even what content is currently being viewed. In this regard, effective advertising is characterized by certain features that include relevancy for the intended recipient of the advertising, cost-effective and efficient delivery of the content, proper selection and management of the content on the device, and formatting of the content for proper display on the device.

A further desirable aspect of a cost-effective advertising program is the ability to obtain feedback regarding the effectiveness of the program with regards to achieving its objectives. As the objective is typically to encourage a recipient to engage in a commerce transaction or at least request additional information regarding a product or service, information regarding how effective an advertisement is in generating such actions is of value to advertisers. As a result, the ability to obtain and process data that tracks how a user responds to advertising content, in terms of accessing related content or engaging in other transactions stimulated by the content is of potentially great value to advertisers, both in terms of revenue collection and in determining advertising budgets for the many available mechanisms for delivery of ad content.

In terms of the characteristics of an effective advertising program, relevancy for the recipient implies the desire to control what advertising content is displayed, when it is displayed, and how the display is integrated with other concurrent activities of the user. This may depend upon device characteristics (what types or modes of data are able to be presented on the device), user profile data (demographic, location or otherwise), contemporaneous or prior user activities (commerce transactions, search activities, etc.), or on the application being used by the intended recipient of an ad at the time the ad is to be displayed (e.g., the type, display characteristics, content, or interactions of the user with the application). For these reasons, the selection and presentation of advertising content is an important feature of any practical advertising delivery system. In addition, cost-effective and efficient delivery of advertising content may depend upon the network infrastructure resources and methods utilized in providing the content and updates to such content to the intended recipients. Further, proper selection and management of the advertising content on the device requires both a content selection policy, as well as techniques for managing the storage of the content in the most effective manner on the device, including addressing the issue of determining what previously stored content to maintain in the event of content updates.

One mechanism for the delivery of advertising content is by means of point-to-point communications between a client device and a source of advertising content, such as an ad server or network operator server. This method is currently used for Internet based advertising, where a client device sends a request for ad content to an ad server, and in response receives the ad content and integrates it into the material being displayed to a user. Such a method is practical because of the relatively high bandwidth, low latency, and dependable connectivity of the network being used to connect the client device and ad server or other source of ad content.

However, the use of mobile and certain other specialized devices, such as ATM machines, informational kiosks, vending machines, or navigation systems introduces additional considerations into an advertising delivery system that may not be present in a fixed high-speed bidirectional system, such as an Internet based communications system. One example would be an automobile navigation system where there is no ability for the user device to communicate with the content serving authority. Another example is that of an information kiosk that may have limited upstream communications capabilities. Yet another example would be a mobile device which must communicate with a central data store or server over a wireless network that may introduce bandwidth constraints, latency concerns, intermittent connectivity problems, and prohibitive cost into any system designed to deliver targeted advertising content to a user of a client device. In addition, the lower available bandwidth as compared to a high-speed wire line network may place constraints on the type or complexity of the content that can be effectively delivered. Also, mobile networks typically can not handle a large number of simultaneous client-initiated unicast transactions without severe adverse impact on other network traffic. Similarly, latency and intermittent connectivity concerns may impact the ability of the client device to communicate with an ad server or other source of content to confirm delivery of content or provide data used to implement an ad presentation policy in a timely manner. In addition, mobile and other specialized devices typically have characteristics that impose constraints on the storage and processing of data that are not present when using desktop computers or other devices connected to a high speed bidirectional network. These constraints may include display size and resolution, data processing speed, and data storage size.

Distributing advertising content and controlling its display to a user of a mobile or other device in a limited resource wired or wireless network environment therefore introduces considerations not typically present in systems that utilize high-speed bidirectional networks. These considerations include how best to deliver the advertising content to be displayed, how to select and control the display of that content, how to control the updating of the content, how to manage the storage of that content on the client device, and how to monitor the recipient's use of that content (so as to obtain data indicative of the effectiveness of the advertising program). Further, from the perspective of a network operator, network infrastructure resource usage becomes an important factor when a large number of intended recipients are involved, as the burden on the network infrastructure and the optimal use of those resources are important considerations that may determine cost to the advertiser and the ability on the part of the operator to deliver the agreed to ad program.

As a result, a threshold issue in designing an advertising delivery system is that of the mode of communication (or content delivery mechanism) between intended recipients and the network infrastructure. Communications between a network operator and individual users may be accomplished by either a point-to-point communication or the broadcast of data to a group of recipients. Each method of communication has certain advantages and associated disadvantages. For example, point-to-point communications are most efficient and cost-effective for a relatively small group of recipients, as they may require significant infrastructure overhead in terms of recipient device addressing, processing of request-response messages and allocation of dedicated bandwidth. An advantage of this mechanism for data transfer is that point-to-point communication may permit real-time or pseudo real-time feedback from the recipient, where such feedback may be used to control content display and track the response to such display (in order to determine ad content effectiveness and pricing models). However, note that such feedback may not always be possible in areas where the network coverage is incomplete or connectivity is unreliable.

In contrast, broadcasting data to a larger group of recipients may be more cost-effective and a better way to allocate network infrastructure resources in certain situations, but it too has disadvantages. Broadcasting enables data to be delivered efficiently to a large group of potential recipients without the need for communicating client-side requests to a server and the associated burden on the network infrastructure. However, control of what data to display to an individual user, as well as updating of the content and display control instructions is not as individualized as in a point-to-point communication situation because all recipients typically receive the same information. Further, in a broadcast environment, feedback from individual recipients is typically not possible, either with regards to confirmation of receipt of the content or with regards to display and follow up actions taken by the recipient.

Thus, although using broadcasting for data transfer has some advantages, in a broadcast mode it is often not practical or possible to individually address a transmission to each member of a large target audience due to network limitations, time restrictions, expense, and/or device characteristics. These and other factors also limit the ability of the network operator or service provider to control the circumstances under which ads can be selected and displayed to members of the target audience.

Depending on the type of content or data involved, the relative advantages and disadvantages of point-to-point and broadcast communication methods may become more or less important. For example, advertising content is most effective and drives advertising and commerce revenue best when targeted at a specific recipient or group of recipients. This targeting may be based on the interests and habits of a recipient, the current location or actions of a recipient, the application executing on a recipient's device, or the display capabilities of the device, among other factors. As a result, targeted advertising is most cost-effective when its presentation (display) can be controlled and the content and control instructions updated as needed to reflect new content and revised processes for determining what content to display and when to display it. Further as mentioned, feedback from the recipient and/or client device can be used to determine the effectiveness of the advertising content and to drive revenue models based on views by recipients and actions taken after viewing an ad (such as accessing a web-site, obtaining further information, or making a purchase).

A number of methods have been suggested to enable the distribution of advertising content and control of the display of that content to mobile and other devices communicating over a network. These methods typically include distributing the content to, and managing a cache of advertising content at the device level. The methods may further include processes for delivering targeted ads to the device based on device characteristics or user actions. However, such methods typically have significant disadvantages. One disadvantage is that such methods typically predetermine (prior to transmission of the data) which ads are to be displayed to the user of the device caching the ads. In such methods, the network operator, service provider or ad content provider determines the policy (i.e., a set of rules or heuristics for determining what content to display and when to display that content) that determines which ads are to be displayed at the time the policy and ad content are communicated to the recipient(s).

Thus, in such cases, the policy is bundled with the content and provided to the recipient devices as an integrated set of data. Hence, if the policy changes, a new set of ads would need to be sent to the device. However, delivering a new set of ads can be expensive in terms of resource usage, or can require a significant amount of time to transfer the data. The result is that real-time modification of ad content and ad selection and display criteria is not practical in some communications environments (such as those in which connectivity is intermittent or bandwidth restrictions limit the ability to deliver content or policy in a timely manner). Furthermore, even if sufficient network resources could be dedicated to updating content and content display policy, the network connectivity and bandwidth limitations may introduce limits to the effectiveness of certain types of advertising, such as that desired to be displayed contemporaneously with an event or user action (such as a coupon or promotional offer that is intended to be delivered substantially contemporaneously with the end of an event).

In addition to binding the ad content and the display policy together at transmission time, the selection of which ads to be sent to each device and cached locally may be determined prior to data transmission by the network operator or service provider. This is typically accomplished using information regarding device characteristics and user actions that are provided by the device intended to receive the ads. Thus, in this approach, the client device on which the ads are to be displayed communicates with the provider of the content to provide data used to filter the ad content that might be provided to the device.

However, this approach has several significant drawbacks. In order to most effectively deliver the ad content, the service or content provider must obtain comprehensive and current (or at least not stale) user and device profile information before sending ads to the device. In some circumstances, this may require an update of that information to ensure that it is current and complete. As an example, it may require that each potential recipient device transmit current profile or other data to the service provider prior to advertising content being transmitted to the device. Although effective, this may place an undesirable burden on network resources if a large number of client devices utilize needed bandwidth and other infrastructure to engage in request-response transactions that result in the transmit of such data to the ad provider.

In addition, if certain profile information about the user or device changes frequently, it can be difficult or impossible for the service provider to keep up with those changes and provide the most cost-effective and network resource-efficient ad content and policy instructions. Also, if selection and display of ad content is to be most effective, it should preferably be relevant to the context in which it is presented. This means that the ad content should be selected based on current user actions, such as the user location or application being executed on the user device. As a result, the above-described approach is sub-optimal because it is primarily static in nature and unable to adapt to changes in user profile, events, and/or device characteristics.

Note that one possible solution to the problems with this approach would be for a service provider to forego the caching of ads on the recipient device and instead rely on a point-to-point communication between the device and the service provider each time the device has an opportunity to display an ad. This approach may be implemented by having a client device request an ad at the appropriate time. As noted, this is typically how web-based banner advertising methods operate. However, this method can be expensive and network resource intensive, requiring a significant amount of bandwidth to receive and respond to a large number or requests and provide a rapid turn-around time. In many networks, especially mobile networks, point-to-point transactions are relatively slow, expensive, and connectivity may be unreliable. Therefore, because of bandwidth limitations and intermittent connectivity between the mobile device and the service provider, this approach may not be practical enough to support an effective targeted advertising program.

Yet another disadvantage of some of the proposed approaches to delivering and controlling the display of advertising content to mobile and other devices is in the area of device (local) data cache management. This refers to the methods used to determine what advertising data to maintain locally, stored in the device's data storage or memory. One approach is to simply empty a cache and replace its contents with an entire new set of advertising content each time new content is provided; however, for many users this may be undesirable as it requires reliable network connectivity and may require substantial time to complete the process. Further, and perhaps more importantly, wholesale replacement of previously cached content may not be a desirable approach for providers of that content because some previously cached content may have greater relevance to a specific user than some of the newly provided content.

As is apparent from the foregoing discussion, there are multiple parameters or factors that influence the design of an effective targeted advertising program. These factors include, but are not limited to, the bundling (or lack of bundling) of content and display policy, the data transfer mechanism by which the content and policy are communicated to a client device and the attendant network infrastructure burdens, the site and means of selection of ad content provided to a client, the process by which the display policy is implemented (i.e., initiated via client or ad server) to request ad content, the ability to provide static, dynamic, real-time, or contextually-based selection of content to display, efficient management of content stored locally in a device cache, and the ability to effectively update content and/or display policy. As noted, careful consideration of the relative importance or value of these factors and the trade-offs implicit in any particular design are important in implementing a cost-effective and resource-efficient advertising program.

Although present approaches to the distribution and display of ad content address some of these issues, they all have significant disadvantages. A more desirable approach to providing advertising content to mobile and other device users operating in a wireless or limited resource wired network should address these disadvantages and provide a more effective and network resource efficient solution. Such an approach would preferably provide the desired network resource allocation and infrastructure usage benefits in combination with the ability to more effectively select and locally manage advertising content, thereby providing highly relevant advertising content to users. Such an approach would be capable of adapting to changes in the advertising content which advertisers desire to show based on real-time events without requiring real-time delivery of new content to all devices in the network. Such an approach would also be capable of adapting to changes in user or device characteristics without incurring substantial network overhead, and also be capable of providing effective tracking data to enable advertisers to determine user actions stimulated by presentation of a particular ad.

What is desired is a system and the associated apparatus and methods for the effective delivery of advertising content and display policy for mobile and other devices operating in a network, and which overcomes the disadvantages of current approaches to providing those capabilities.

### BRIEF SUMMARY OF THE INVENTION

The present invention is directed to a system and associated apparatus and methods for distributing advertising content to mobile and other devices operating in a network, and for managing the display and updating of that content. The invention utilizes a broadcast mode of communication to deliver ad content and ad display policy data to each of a group of recipient devices, where the ad content data and policy data may be delivered and/or updated independently of each other. The ad content may be filtered at one or both of the service (content) provider or local device to provide a more optimal selection of ads available for display to each user. Selection of ad content for display is determined by execution of the ad policy, which is delivered by the ad content provider and determines the selection, timing, and display method of ads stored in the local device cache. Policy changes at the service or content provider are delivered real-time or pseudo real-time to the user devices so that changes in ad selection and display take effect substantially contemporaneously with changes in policy. The ad content policy may be contextual so that the ad content to be displayed is selected based on user location, user actions or characteristics of the user device or application being executed on the device.

The invention is implemented as part of a client-server architecture in which an ad module resident on the user device controls caching of the ad content data and implementation of the ad selection and display policy. The ad module may be a set of executable instructions implemented by a processing element, a state machine, or other form of control instructions, and is commonly accessible by any or all applications on the user device. The policy functions to select ads from the device cache for presentation to a user via an application executing on the device. The ad module is capable of tracking usage statistics and actions of the user in response to the ad that can be used for refinement of the ad policy at the device level or shared with the service or content provider to affect policy changes for a larger group of recipients. The usage statistics or metrics can also be used as part of generating revenue based on user response to displayed ads, such as follow-up searches, requests for additional information, or transactions initiated by a user in response to display of an ad. Further, the ad module is capable of cache management operations to most effectively determine which ad content to maintain in the device cache in the situation where new content is made available.

In one embodiment, the present invention is directed to a system for the distribution and display of advertising content to a device. The system comprises an advertising server configured to communicate with a data distribution network, where the advertising server includes an advertising policy module configured to create and manage the distribution of an advertising policy, where the advertising policy controls the selection of the advertising content for display to a user of the device, an advertising manager module configured to control the distribution of the advertising content to the user of the device, and an advertising content usage module configured to obtain and process advertising content usage data from the device. The system further comprises an advertising module resident on the device and configured to communicate with the data distribution network, the advertising module including an advertising cache for storage of the advertising content, an advertising cache management module for managing the storage of the advertising content in the advertising cache, an advertising display policy management module capable of receiving, storing, and executing display policies distributed by the advertising policy module on the advertising server, an interface configured to allow an application capable of executing on the device to interact with the advertising module in order to obtain advertising content stored in the cache for display to the user of the device, and an advertising content usage data module configured to provide data regarding the display and usage of the advertising content to the advertising content usage module of the advertising server, wherein the system operates to distribute the advertising content and advertising policy separately to the device over the data distribution network by broadcasting the advertising content and advertising policy data to the device.

In another embodiment, the present invention is directed to a method of distributing advertising content data to a plurality of devices. The method comprises broadcasting the advertising content data over a communications network, broadcasting advertising policy data over the communications network, where the advertising policy data controls the selection of the advertising content data for display to a user of each of the devices, and wherein the advertising content data and advertising policy data are broadcast separately from each other. The method further comprises, for each of the plurality of devices, receiving the advertising content and advertising policy data, storing the advertising content data in an advertising cache, registering an application capable of executing on the device, notifying the application to display advertising content to a user of the device, where the notification is generated in accordance with the advertising policy data, accessing the advertising cache to obtain the advertising content to display to the user of the device, and displaying the accessed advertising content to the user of the device.

In yet another embodiment, the present invention is directed to a device for displaying advertising content data, where the device comprises a process executing on the device to receive the advertising content data from a communications network, a process executing on the device to receive advertising policy data from a communications network, the advertising policy data acting to control the selection of advertising content data for display to a user of the device and the advertising content data and advertising policy data being broadcast separately over the network to the device, and a process executing on the device to control storage of the received advertising content data in a device cache, where the process is configured to assess the relevancy of the advertising content data to the user of the device prior to determining whether or not to store the advertising content data in the advertising cache.

Further, in multiple embodiments, the present invention is directed to a system, and associated methods and apparatus for distributing advertising content data to a plurality of devices, where those devices may be mobile devices such as mobile phones, PDAs, etc., or the devices may be relatively fixed-location devices such as vending machines, automated teller machines, or informational kiosks that may serve a multiplicity of users. In each case the device comprises a process executing on the device to receive the advertising content data from a wired or wireless communications network, a process executing on the device to receive advertising policy data from a wired or wireless communications network, where the advertising policy data acts to control the selection of advertising content data for display to a user of the device, and the advertising content data and advertising policy data may be broadcast separately over the network to the device. The device further includes an interface configured to allow an application capable of executing on the device to interact with an advertising module on the device in order to obtain advertising content stored in a cache for display to the user of the device based on the characteristics of the user, and an advertising content usage data module configured to provide data regarding the display and usage of the advertising content. Further, the invention operates to distribute the advertising content and advertising policy separately to the device over the data distribution network by broadcasting the advertising content and advertising policy data to the device.

Other objects and advantages of the present invention will be apparent to one of ordinary skill in the art upon review of the figures and accompanying detailed description of the present invention.

### BRIEF DESCRIPTION OF THE DRAWINGS

FIG. 1 is a functional block diagram illustrating the primary functional elements of a system representing one embodiment of the present invention;

FIG. 2 is a functional block diagram showing the primary functional elements of FIG. 1 in greater detail;

FIG. 3 is a diagram illustrating an example of a multi-modal ad content bundle that may be utilized with the present invention;

FIG. 4 is a functional block diagram and associated description illustrating a process by which a change in the ad content display policy may be distributed and executed by recipient client devices in the network, in accordance with an embodiment of the present invention;

FIG. 5 is a functional block diagram and associated description illustrating the primary functions of the local ad filter and cache management process resident on a recipient device in accordance with one embodiment of the present invention;

FIG. 6 is a functional block diagram and associated description illustrating a process by which a locally resident active ad content selection policy may be used to select ad content for display in accordance with one embodiment of the present invention; and

FIG. 7 is a functional block diagram and associated description illustrating the primary functions of the server ad filter in accordance with one embodiment of the present invention.

### DETAILED DESCRIPTION OF AN EMBODIMENT OF THE INVENTION

The present invention is directed to a system and associated apparatus and methods for the efficient distribution of advertisements to, and control of the display of those advertisements on a device operating in a network. Although the invention is intended for use in a broadcast environment and will be discussed with reference to that mode of data transfer, it is to be understood that some of its methods and techniques may be used in other environments as well.

In order to make the following discussion of the embodiments and benefits of the present invention better and more fully understood, it is useful to introduce certain terms and definitions that will be used. It is to be understood that these terms and definitions are introduced for purposes of clarity and not to place restrictions or constraints upon the described embodiments of the invention or the claimed invention.

In the discussion of the present invention, the following terms will be understood to have the following general meanings:

Ad Bundle: An ad bundle contains multiple presentations or modes of the same ad. For example, it can contain a presentation for text only display, another presentation for static image display, and another presentation for full-screen video display. The ad bundle also may contain a description of the ad that can be used by the ad policy to determine whether or not to choose that ad for display. This description may include keywords, context descriptions for desired display, rules, and other metadata.

Ad Display Policy: The ad display policy is a policy or set of rules or heuristics executed on a device when an application on the device requests an ad for presentation to the user. The policy may be active (e.g., notifying an application that an ad is to be displayed) or may be passive and respond to a request from an executing application. The policy is controlled by the service provider and may be distributed to all devices in the network in a real-time or pseudo real-time manner.

Ad Cache: A data storage area on a local device where received ad content may be placed for future access.

Ad Cache Refinement: A mechanism for managing the local storage of ad content, for example by determining whether new ads that are received should be stored in whole, in part, or discarded. As will be discussed, one possible method is to compare new ad content to ads already present in the cache and determine whether the new ad content is of greater relevance to the user of the device. If so, the new ad may be used to replace a less relevant ad currently in the cache. This determination/comparison can be made by scoring the ads such that higher scores indicate a higher level of expected interest to the user of the device.

Ad Module: A secure and trusted client process executing on one or more devices in the network. The process may be implemented as a set of executable instructions capable of execution by a processing element, a state machine, or other form of instructions capable of controlling the selection and presentation of ad content. The process provides a set of APIs (application programming interfaces) to applications executing on those devices that may be used to access and control the selection and display of ad content. Among other functions, ad cache management, ad policy execution, and reporting metrics are managed by the ad module.

Note that in the following discussion and description of the figures, certain elements may be represented by the same numbers with those numbers appearing in different figures. In such a case, the element referred to is intended to represent the same or equivalent element in both figures and, where applicable, with regards to the accompanying description for those figures.

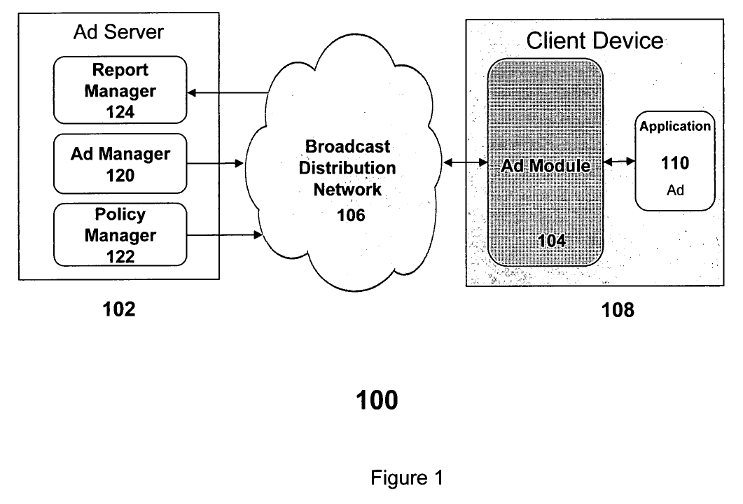

FIG. 1 is a functional block diagram illustrating the primary functional elements of a system 100 representing one embodiment of the present invention. As shown in the figure, these elements include a server component (identified as “Ad Server” in the figure) 102 and a client component (identified as “Ad module” in the figure) 104. The Ad server 102 represents one or more executable processes resident on a server that is capable of communication with a carrier or operator network (identified as “Broadcast Distribution Network” in the figure) 106, for example. Network 106 may be a wired or wireless communications network, for example. Ad module 104 represents one or more executable processes resident on a Client Device 108, where client device 108 is capable of communication with network 106. Client Device 108 may be a wireless mobile phone, PDA, ticket vending machine, automated teller machine, information kiosk, or wireless connected laptop computer, for example.

In broad terms, Ad Server 102 is responsible for distributing ad content and ad display policies, and for collecting usage metrics from each recipient device in the network. As noted, some or all devices in the network contain Ad Module 104 that is broadly responsible for retrieving and caching the ad content transferred over the network, obtaining and executing the ad display policies, providing applications (e.g., element 110) on the device a common API for obtaining and displaying ads, and collecting statistics on the ads displayed and if desired, follow up actions by a user to report back to the Ad Server.

As shown in the figure, Ad Server 102 includes one or more modules that implement the inventive methods and processes. These modules include Ad Server Ad Manager Module 120, Ad Server Policy Manager Module 122, and Ad Server Report Manager Module 124.

In broad terms, Ad Manager Module 120 is responsible for collecting ads from various possible sources of ad content and controlling the distribution of those ads to client devices capable of communication with network 106. These sources could include, for example, ad networks, which aggregate ads from a number of sources, an ad content feed provided over a network (such as the Internet), or individual advertisers.

When distributing ads for transfer over network 106, ad manager module 120 is capable of filtering ad content based on a number of attributes, including, but not limited to:
time (e.g., hour/minute, day, month, season);
geographic location;
network status (e.g., resource utilization, bandwidth constraints or usage, connectivity);
demographics data concerning the user population (user profiles, habits, etc.); or
carrier or operator brand or characteristics (for purposes of co-branding, implementing specific business models).

In accordance with the present invention, ad content can be distributed over the network to the client devices in a number of ways. For example, ad content can be continuously broadcast over one or more channels which are monitored by devices in the network. Alternatively, ad content can be broadcast at only certain times of the day, such as overnight or during non-peak hours, as a way of more optimally utilizing the network resources (with the client devices made aware of this practice and configured to “tune in” to the broadcast of the ad content). Another possible method is to have some or all of the client devices initiate a point-to-point connection with the ad manager at regular intervals to obtain ad content (note that this method would likely be optimal only for a network that could support relatively large numbers of simultaneous requests for connections from the receiving client devices).

When broadcasting ad content, there are several mechanisms by which the ads and their corresponding metadata can be delivered (where the metadata may include information such as descriptive keywords, ad characteristics (size, modality, etc.), selection criteria, etc.). One method is to have the ad relevant metadata contained within the ad itself. In this situation, a client device would be configured to read the entire ad and its metadata, and then determine whether the ad should be cached or not. Another possible mechanism is to broadcast an ad catalogue which contains a list of the ads, their associated metadata, and where they can be found. A client device would then access the entire catalogue, apply an appropriate filter to each item to determine which ads are to be retrieved to fill the cache, and then retrieve the desired ads. Retrieving the ads may be implemented by listening to a particular broadcast channel that contains all the ads and pulling those ads that are desired, for example. In a non-broadcast data transfer environment, the device may contact the ad manager and request the ads that are to be retrieved and cached locally in the client device. Further, in an implementation where a service guide is made available to the subscriber population, the ad catalogue can be included with the service guide and then acted upon by the client device to identify the desired content.

Ad sever policy manager module 122 is responsible for creating, managing, and ensuring proper distribution of the policies that are to be implemented by the client devices to control the selection and display of ad content. This may include the real-time, pseudo real-time or other desired distribution of policy changes to all appropriate devices in the network. In this regard, note that the network operator (in accordance with policy desires of the providers of ad content and/or as part of the operators' own content policy decisions) can create or modify content display policies and have them delivered immediately, or schedule to have them delivered at a future time.

As with ad content, ad selection and display policies can be distributed to devices within the network using a variety of methods. For example, devices in the network can be instructed to listen to or regularly monitor a broadcast channel that contains new ad policy information when it is available. In this way, when policy manager module 122 has a new or revised ad policy to distribute, it can place the policy data on the broadcast channel to be received and implemented by client devices. To increase the likelihood of reception by the desired recipient devices, the current policy can be rebroadcast at regular intervals so that devices which may not have been listening or capable of connectivity when the policy was first broadcast are able to receive the update.

In the case of using a non-broadcast data transfer mechanism, devices in the network can poll policy manager module 122 to ask if a new policy is available (or to obtain the current policy if they do not have it available). The new or current policy can be sent in the response to the poll, or the device can make a subsequent request to obtain the new policy if one is available. Another possible mechanism is for policy manager module 122 to issue a notification to devices in the network to indicate that a new policy is available. Devices can then contact the policy manager to obtain the new policy at a time appropriate for that device (or in accordance with a schedule communicated by the policy manager). Note that some of these methods depend on the availability of point-to-point communications between devices in the network and policy manager module 122. Since ad policies are typically relatively small amounts of data compared to the ad content itself, this may be an acceptable solution. However, note that in certain types of networks such as some mobile phone networks, such methods may still be undesirable due to network bandwidth limitations, congestion, or device limitations.

Report manager module 124 is responsible for performing certain of the ad content usage and tracking operations of the present invention. Specifically, report manager module 124 obtains ad usage data or reports from client devices in the network, processes that data, and makes the processed data available for use by the network operator and advertisers. The processed data can be used, among other things, to determine the effectiveness of specific ads in generating desired user actions, calculating pricing models for ads and placement of ads, or as inputs to determine the revenue generated for the operator by charging the advertiser for distribution of the ad. Since reporting statistics typically requires a client initiated point-to-point connection, the reporting activity may need to be controlled to prevent network congestion. In this regard, the server may control the frequency of reporting by telling the client devices when to report next, or by requiring that the device receive a report request from the server either via broadcast or point-to-point communications before reporting statistics. Further, a broadcast report request that may be received by all devices in the network may indicate that only a portion of those devices receiving the request report their usage statistics so as to minimize the impact of those reports on the network.

As noted, ad usage statistics can be used by the network operator for billing and pricing purposes. However, they can also be used to further refine the content stored locally in the ad cache on a client device or the policies distributed to the client population. Further, the statistics can also be used to support a bidding system for advertisers who desire to have their ad content featured more prominently. This is because without needing to repopulate the ad content cache, and using a minor policy change that can be quickly distributed throughout the network, one advertiser can outbid another to increase the number of ad displays their products get and have that result communicated to and implemented by devices in the network.

On the client side of system 100, ad module 104 is generally responsible for retrieving ad content and ad policy data from the network and implementing that policy (alone or in accordance with information provided by sources such as the application executing on the client device and/or user profile data) to control selection and display of the content. Ad module 104 is also responsible for certain aspects of the cache management functions implemented as part of the inventive system.

As noted, ad module 104 may monitor the network for ad content being delivered over the network. This can be done by listening at predetermined times to a broadcast stream, or by being addressed directly by ad server 102. Ad server 102 may send a cache purge event to the client, the result of which is to cause ad module 104 to delete all ads in the ad cache. This may be used when the network operator wants to send a fresh set of ads to all devices in the network.

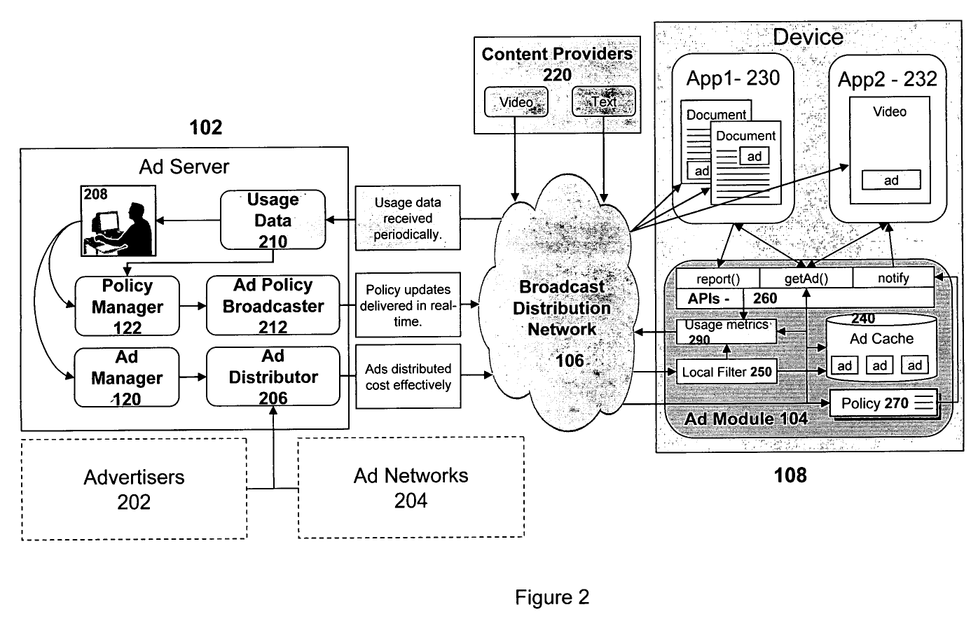

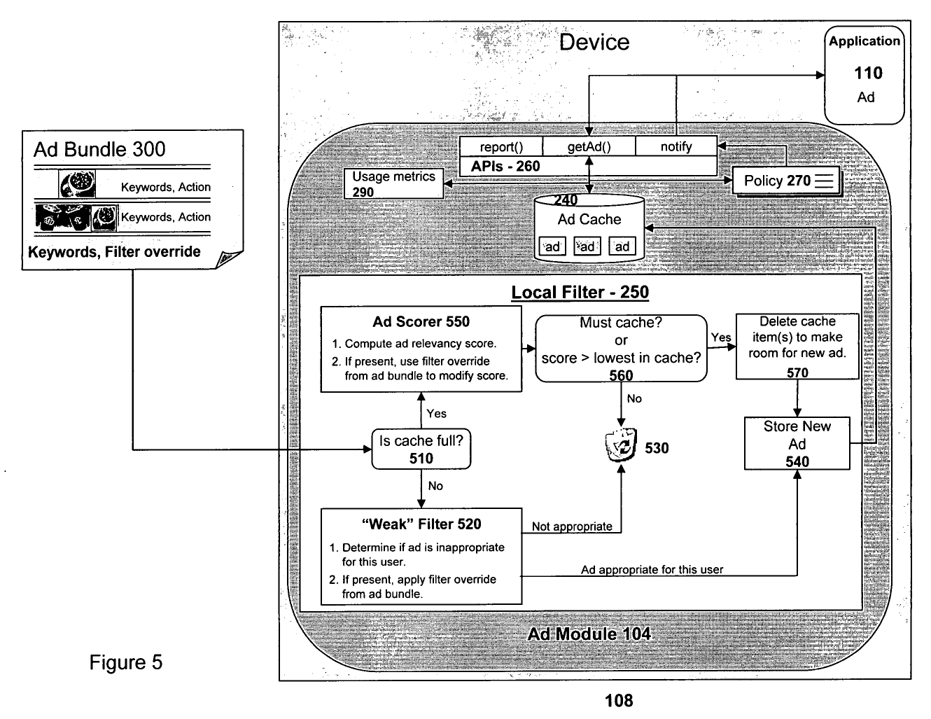

The cache management functions performed by ad module 104 are primarily intended for the purpose of optimizing the use of the limited data storage space available on client device 108 without sacrificing potentially relevant ad content. Because of the limited storage space available on some devices, it is important to maximize (where possible) the relevance and effectiveness of the content stored in the cache. Further, because some previously distributed ad content may have greater relevance for a user or set of users than newer ad content, it is desirable that the cache management functions be capable of implementing a decision process that takes this into account (as opposed to simply flushing a cache and replacing it with new content, or removing content having a date older than a certain date, etc.). An example of such a decision process suitable for use with the present invention will be described with reference to FIGS. 2 and 5.

In addition to retrieving ad content, ad module 104 also is responsible for retrieving and controlling the implementation of the policies that control the selection and display of ad content. As with the ad content, ad module 104 may monitor the network for ad display policies delivered over the network. As with the ad content itself, this can be done by listening at predetermined times to a broadcast stream, or by being addressed directly by the server. Note that an ad display policy that is received may be effective immediately, not be effective until a future point in time, or not be effective until a triggering event occurs.

When an application 110 (such as a stock quote display, search engine, sportscast, newscast, game, etc.) executing on client device 108 requests an ad for display to the user, the ad display policy is executed to determine which ad to deliver to the requesting application. The display policy may utilize current local device conditions, user location, user profile information, and/or additional information supplied by the requesting application in executing the policy. Note that display policies can be active in the sense of requiring applications to rotate ads periodically. In this case, applications may be notified when a new ad should be displayed. The application will then ask for a new ad when it is ready to display the new content.

As discussed with reference to ad server report manager module 124, the collection and processing of ad usage statistics is an important function of the inventive system. In this regard, ad module 104 is capable of providing detailed ad usage and reporting services to the network operator, service provider, or ad content provider. The ad usage data can be used to further refine the contents of the ad cache (by supplying data used to make decisions whether to remove or retain ad content in the cache), or to refine the policy used to select and display the ad content. Example statistics that may be collected include, but are not limited to:
ads that were accepted into the cache;
ads that were rejected and not cached;
ads that were replaced in the cache;
ad cache scores;
the number of times an ad is viewed;
how long the ad was displayed to the user;
the number and details of the different levels of a multi-modal ad viewed, such as the text version, static image version, full screen animation version, or thumbnail animation without audio;
the times of day the ad content was viewed;
the types of applications that showed the ad;
the number of times the user selected an ad for additional information;
the number of times and destinations of ad clicks executed by the user;
the keywords supplied by applications that caused the ad to be displayed; and
any or all other criteria that caused the ad to be selected and displayed to the user, such as device state, user profile, user location, user history, etc.

Note that the statistics can be collected over a period of time and provided to the network operator, etc. on a scheduled basis, or upon request. Note further that ad module 104 may rely upon the application executing on the client device for certain data or statistics. For example, the length of time an ad is displayed to the user may be controlled and tracked by the application. In this scenario ad module 104 knows that the ad was asked for and delivered, but not necessarily how long it was on the application's screen, or if it was displayed at all. Note that not all applications may be counted on to provide reliable information concerning the use of an ad. For this reason, ad module 104 may distinguish between trusted applications and non-trusted applications. The statistics stored will reflect or may depend upon the type of application that did the reporting. Alternatively, ad module 104 can provide an API that allows the ad module itself to take over part of the screen for displaying an ad. This requires that the client device provide a mechanism to hand a portion of the screen over from the current application to the ad module. If available, this ensures the gathering of reliable ad statistics regardless of the level of trust an application has been granted.

FIG. 2 is a functional block diagram showing the primary functional elements of FIG. 1 in greater detail. As shown in the figure, Ad Server 102 may receive Ad content from a variety of sources, including but not limited to, one or more Advertisers 202 and/or Ad Networks 204. An Ad Network 204 may represent one or more individual or groups of advertisers who provide content to the Ad Network for distribution. Ad content provided by these and/or other sources is made available for distribution over network 106 by Ad Distributor Module 206. Ad Server 102 further may include or be accessed by Ad Policy Creator 208. Ad Policy Creator 208 may be a process, or a person or persons responsible for defining the ad policy for a set of ad content. Examples may include an executable set of instructions or heuristics that define a policy, an advertising agency representative, or a representative of a network operator. Such entities may act independently to define an entire policy or co-operate to jointly define a policy.

Ad policy creator 208 may receive usage data and/or ad content usage reports from Report Manager module 124 of FIG. 1 or an equivalent element and utilize that data and/or reports to define and/or refine an ad policy. Ad policies created and/or modified by Ad Policy creator 208 are provided to ad policy manager 122 and Ad Manager 120, whose functions have been described with reference to FIG. 1. Ad Policy broadcaster 212 is responsible for controlling the distribution of new, modified, or refined ad policy data to the network 106. As noted, Ad Distributor 206 is responsible for controlling the distribution of new, modified, or refined ad content data to network 106.

An important aspect of the present invention is that it does not require, and in most circumstances anticipates that ad content data and ad policy data are not bundled together, and instead may be created, modified, refined, and distributed independently of each other. This is a result of having the ad content and ad policy distributed to network 106 by Ad Distributor 206 and Ad Policy Broadcaster 212, respectively, where ad content or ad policy may be broadcast over network 106 at different times and in whatever manner is most cost-effective and efficient.

Note that as shown in the figure, Content Providers 220 may provide content in the form of video, text, or audio data to be broadcast over network 106. This data may include, for example, ad content, the selection and display of which is controlled by the ad policy.

Continuing with the description of FIG. 2, Client Device 108 includes Ad Module 104 and typically further includes one or more applications (illustrated as App1 230 and App2 232 in the figure) that have been installed and are capable of being executed on device 108. App1 230 and App2 232 are merely examples of possible applications, and may include, but are not limited to, messaging applications, games, document related applications for presenting and/or editing documents, an application to enable reception and presentation of a newscast, sportscast, or notification, a provider of stock data, an application to facilitate a commerce transaction, etc. The content presented by the application or applications may include, but is not limited to, text, audio, images, or video.

Ad Module 104 includes an ad Cache 240 that is used to locally store ad content received over network 106 (as suggested by the boxes labeled “ad” in the figure). Although Ad Cache 240 is shown as being an element of Ad Module 104, note that it may also be implemented as part of another data storage element that is part of client device 108, such as the device's own local data storage element. Ad Module 104 may also contain a local ad filter 250 that may be used to filter received ad content prior to it being selected for storage in Ad Cache 240 based on user preferences, user location, user profile, user behavior, etc. Note that local filter 250 may remove ad content from data that is to be stored in ad cache 240, or “tag” such data before it is stored, thereby controlling whether it is displayed currently (but not later), not currently but instead later, or not at all, for example.

Ad cache 240 is an important component of the inventive system. In operation, the cache will typically contain a variety of user targeted ads that can be used in the selection process defined by the ad policy. There are a number of environments and use cases where real-time delivery of ads to many users in a large population is not realistic or practical. This can be due to bandwidth limitations, device limitations, network traffic management, or other provisioning issues.

In such cases and in general, maintaining an ad cache provides several distinct advantages. For example, it provides flexibility in the delivery of ads to the user population. The cache can be populated slowly over time, or more quickly during off-peak periods of network usage. Content stored in the cache can be filtered locally based on physical device characteristics such as display size or audio-visual capabilities, environmental device characteristics such as signal strength or GPS location, user preferences such as hobbies or services subscribed to, user profile such as age or gender, or usage history such as which applications have been run recently or which ads were clicked on recently. One or more of these filters can be used to build a collection of ads of specific interest to the user of the device. A locally resident cache also allows multiple applications to have access to the same set of ads through a common ad module or interface. For example, the inventive ad module uses the cache to provide access to a variety of ads that, while of special interest to the user, might only be appropriate at certain times or in certain contexts for particular applications.

Note that rules, heuristics, or algorithms used to filter ad content locally can be preloaded onto the device, or updated by the service provider or network operator and distributed to the users on a periodic or predetermined basis. For example, when the device periodically contacts the service provider to authenticate continued access to a particular service or channel, the service provider has an opportunity to update the local filters that particular device uses when populating the ad cache.

Although the ad cache is initially populated in a manner so as to have ads available to most, if not all, applications, in accordance with the present invention, over time as more ads are received, the cache's contents are refined to better suit the user of the device. This means that once the cache is full or nearly full, items currently in the cache may be removed to make room for ads that are more appropriate or relevant to the user. As will be described with reference to FIG. 5, this can be accomplished using a scoring system that assigns a relevancy score to each ad received. Scoring may be based on keywords and/or other metadata included with the ad, where higher scores are assigned to ads that would be more relevant, or of special interest to the device or its user. Once the cache is full or nearly full, new ads that score higher than the ads currently in the cache would overwrite and replace the lower scoring ads. Note that the service provider or network operator can override scoring by specifying that an ad must be placed in the cache regardless of score.

Further, even when initially filling the cache, it may be desirable to not store certain ads even if that means there might be no ads to provide for a particular application. For example, a child's device would not store beer ads, even if there is room in the cache. This may be accomplished by using two filters, one for when the cache is full, and one for when the cache is not full. The cache scoring mechanism to be described would then be in effect when the cache is full or nearly full. When the cache is not full, a weak filter may be used, where such filter, instead of scoring the ads, determines if an ad is inappropriate for the user, and if so, refrains from caching that ad.

As recognized by the inventors, it may be desirable to override the cache scoring mechanism at times. For example, the ad aggregator, network operator, etc. may desire to push the same ad to all devices in the network, regardless of how well they score on each individual device. This can be accomplished by providing an override filter with the ad itself, such as “always cache”, or something more complex, such as “only cache on devices with a screen size of 320 by 160 or greater”.

The service provider, network operator, etc. may wish to exert additional control over the cache population by specifying an expiration time for the entire cache, or for a particular ad or ads in the cache, or by maintaining the ability to send a cache flush event that would empty the cache and cause each device to start populating the cache again. This might be useful if a complete new set of ads have been provisioned and are intended to replace any existing ads that were previously delivered, regardless of score.

Note that the service provider, network operator, etc. has control over the timing of ad cache population and refinement processes. For example, a service provider may want to distribute ads during off peak periods of network usage at a high rate, and then suspend distribution during peak hours. Alternatively, the service provider may send ads at higher rates during off peak hours and lower rates during peak hours. Further, the service provider may choose to distribute ads at a constant rate throughout the day, but increase the volume in real-time if a significant number of new advertisers are acquired.

Ad Module 104 also includes one or more application programming interfaces (APIs) 260 that provide a way for applications executing on client device 108 to interact with Ad Module 104 and implement the ad content selection, display, and tracking functions of the present invention. The APIs 260 typically include a process to enable Ad Module 104 to notify (shown as “notify” in the figure) an application that ad content is to be displayed to a user of a registered application. This is an example of an active ad policy whereby the policy informs the application that it is the proper time, client device location or state of the application for an ad to be displayed. As shown in the figure, in such an example, the Ad Policy data 270 stored in Ad Module 104 triggers the notification process in accordance with its rules or heuristics. As will be described, an application may also request ad content in accordance with its own state of execution, rather than as a result of receiving a notification.

In general terms, when an executing application is in a state where it has an opportunity or is otherwise instructed to display an ad, it will call an API in the ad module to obtain an ad to display. In response, the ad module will execute the current ad policy to determine which ad from the cache to return to the application. Note that the application may provide keywords, context information, or supported display characteristics to be used in the selection of the ad.

The ad module may also support integration with a built-in web, WAP (wireless application protocol), or other type of browser. This provides web or WAP compliant pages being hosted outside, but viewed on the client device the ability to make calls to the ad module in order to insert locally cached ads into the web or WAP page. This can be accomplished, for example, by using the localhost URL notation, such as:
<img src=‘http://localhost/admodule.cgi?keywords=big,apple,food’/>

### Other mechanisms that are agreed upon between the web or WAP browser publisher and the ad module can be used as well.

Ad policies can be active, as opposed to only being executed when an application requests an ad. For example, active policies may notify applications when specific ads are to be displayed. In an ad rotation scheme, the policy may notify applications when a new ad is to be rotated in. This eliminates the need for each application to implement its own rotation algorithm or process, and ensures that the policy is defined by the operator.

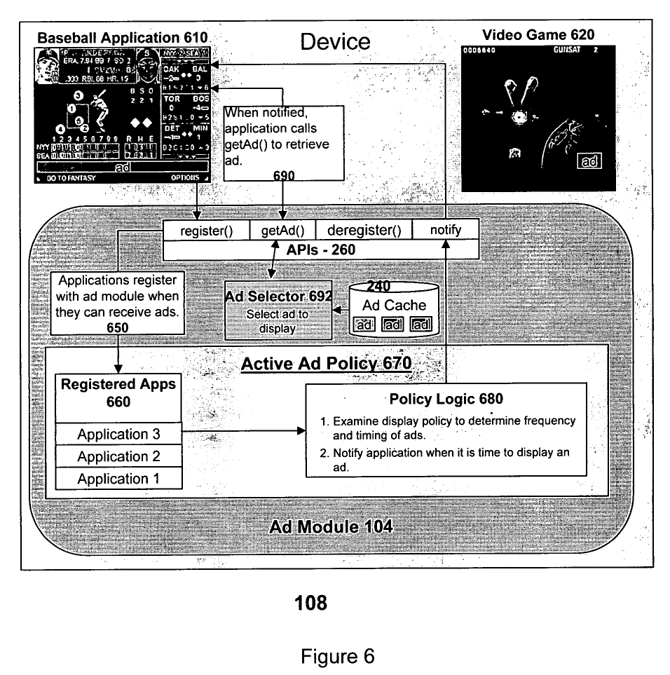

As discussed, to support real-time notification to applications that an ad should be displayed, or that an on screen ad should be rotated out and replaced with a different ad, the ad module provides several APIs. When an application begins execution, or enters a state where ads can be displayed, the application calls the ad module's register API to inform the ad module that the application can receive ad notifications. The application will provide the register API with a callback function that the ad module can call. The callback function will be called by the ad module when a new ad needs to be displayed. When an application ends, or enters a state where it can not display ads, the application will call a deregister API that informs the ad module that the application will no longer respond to display requests. Note that multiple applications can be registered with the ad module at the same time. This is typical in multitasking environments where multiple applications share the screen. FIG. 6 and the accompanying description provide further details about this feature of the present invention.

Whether as a result of receiving a notification or as a result of making a request for ad content, an application may acquire ad content using a getAd( ) process API. This process represents an API that enables an application to access ad content data stored in Ad Cache 240. In addition, Ad Module 104 includes a report( ) API that represents a process that enables an application to provide usage data, metrics, or other forms of reporting data regarding ad content. This data may be stored in a usage metrics element 290 that is configured to provide such data in either raw or processed form to network 106 for transfer to Ad Server 102.

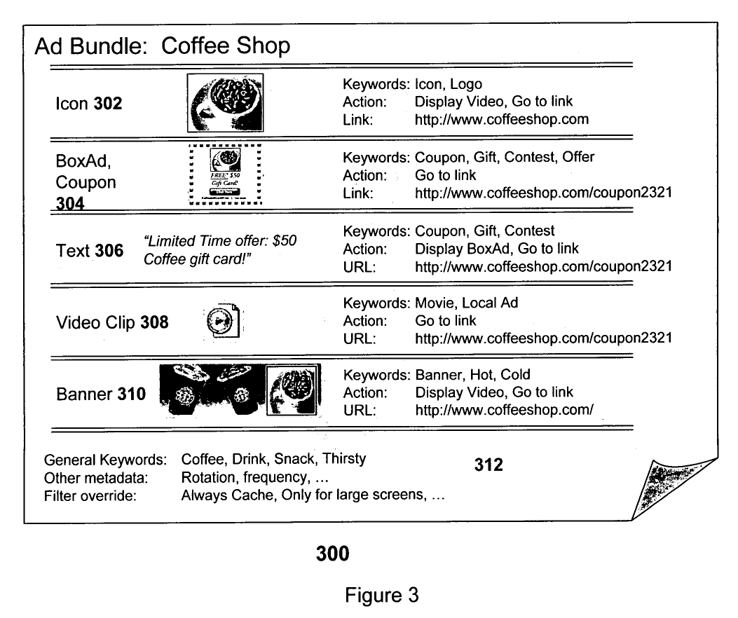

FIG. 3 is a diagram illustrating an example of a multi-modal ad content bundle 300 that may be utilized with the present invention. As shown in the figure, ad bundle 300 may include one or more types or modes of ad content (i.e., content designed for presentation as an ad that may have multiple formats or forms). These may include, but are not limited to, an Icon 302, Box Ad or Coupon 304, Text data 306, a Video clip 308, or Banner ad 310. Further, each type or mode of ad content may include related meta-data, such as keywords for the selection of the data type or mode, an action describing its desired usage, or a link to other related data that may be accessed during the content presentation process. The bundle itself may further include global meta-data 312 intended to control the general selection and display of content in the bundle, such as keywords, data describing the intended presentation of the ad content, or instructions for controlling the caching of the content.

As noted, ad content can be multi-modal, meaning that one ad bundle can have a number of display modes or formats for the ad content. For example, where only text is allowed or feasible for a client device or application, the ad will be rendered using only text. Static images or movie clips of the same ad can be made available for use when the application supports those formats. Typically, the application specifies what format is supported, and the local ad module makes the decision as to what to provide to the application, based on the current policy in effect.

Since multi-modal ads generally have multiple levels of detail, if a user expresses interest in a particular ad, additional information concerning the ad can be displayed to the user directly from the ad cache. For example, if a user selects a static ad image, a short video further explaining the ad can be shown to the user directly from the cache without needing to retrieve additional information over the network.

As discussed, to support multi-modal ads, ads are sent as bundles, where two or more levels of ad information may be provided: general information about all ad formats in the bundle; and specific information for each ad format included in the bundle. For example, general information might include keywords about the company sponsoring the ad or product or service mentioned in the ad. Specific information for a particular format might include additional keywords, display characteristics, and/or what action to take when the user selects the ad for more information.

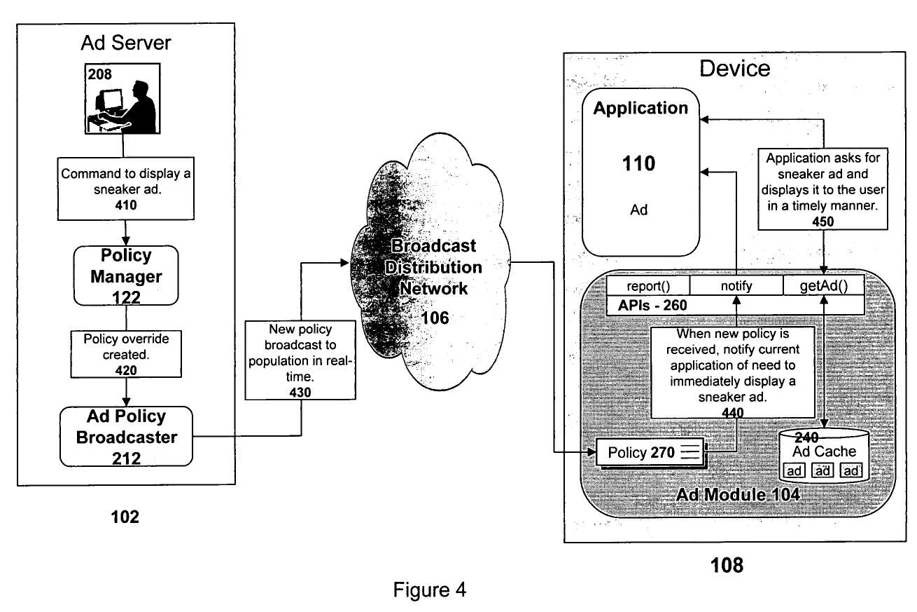

FIG. 4 is a functional block diagram and associated description illustrating a process by which a change in the ad content display policy may be distributed and executed by recipient client devices in the network, in accordance with an embodiment of the present invention. As described with reference to FIG. 2, Ad Policy Creator 208 may be a process, or a person or persons responsible for defining the ad policy for a set of ad content. In the case of a change to a previously distributed ad policy, Ad Policy Creator 208 may be a network operator implementing a change in policy desired on their own part, or on the part of a provider of ad content or ad policy.

In any case, a change in ad policy is desired, and is communicated to Ad Policy Manager 122 by the issuance of a command or execution of a specified instruction or process (stage 410 in the figure). For the example shown, the desired change in policy is to display an ad for a sneaker or other specified product (now or contemporaneously with another indicated event). The command is received by Ad Policy Manager 122 which interprets the command as requesting a change in the existing (i.e., currently implemented) ad policy. Ad Policy Manager 122 creates a policy override to implement the desired change in policy. This “override policy” may be in the form of policy override data that is intended to override existing policy for a period until it is implemented, a modified ad policy that incorporates the desired change(s), or a partial ad policy that incorporates the desired new policy features and is intended to temporarily replace the presently implemented policy. The policy override, revised policy, or partial ad policy is provided to Ad Policy Broadcaster 212 which is the element responsible for providing the policy to the broadcast network 106 (as shown at stage 430 in the figure). The network 106 distributes the policy override via broadcasting to a set of recipient client devices.

The revised or override policy is received by a client device and provided to Ad Policy Module which stores Ad Policy data 270, and which is typically an element of Ad Module 104. In accordance with the operation of the present invention, when new or revised ad policy data is received, the new or revised policy instructions are implemented as required by the policy. In the present example of a policy override to cause the display of a particular ad at a particular time, the currently executing application (element 110 in the figure) is notified via the relevant API 260 that the application should display the desired sneaker ad (stage 440 in the figure). The notify process triggered by the API in turn causes application 110 to request the desired ad content using the getAd( ) API (as shown at stage 450 in the figure). Application 110 receives the requested ad content from Ad Cache 240 as a result of the getAd( ) API call, and presents the Ad to the user of the client device.

The above description of the creation and implementation of a policy override is an example of how the present invention is capable of altering the execution of an existing ad policy in a cost-effective and network resource-efficient manner. As a result of the ad content and ad policy being communicated separately to client devices, changes to policy may be implemented quickly (real-time or pseudo real-time) with minimal use of network resources. This is an important feature because it permits network operators, ad managers, or other creators of ad policy to implement changes in policy designed to take advantage of current events, sporting event results, the end of a concert or other event, etc., by using that event as the basis for displaying a highly relevant ad.

FIG. 5 is a functional block diagram and associated description illustrating the primary functions of the local ad filter and cache management process resident on a recipient device in accordance with one embodiment of the present invention. As has been discussed, the cache management and filtering processes implemented by the present invention serve an important function because they permit the intelligent optimization of how the client device uses its local data storage capacity to store ad content data. In the following description these processes are implemented by Local Filter 250, although it is to be understood that they may be performed by other elements as well. Note that local filter 250 may apply one or more filtering rules, heuristics, algorithms or the like to determine whether ad content should be stored locally or discarded. Examples of possible local filtering rules, etc. include, but are not limited to:

Device characteristics or operating conditions such as:
audio-video capabilities
exact GPS location
signal strength
cache size
   User profile data or user characteristics such as:
age
gender
interests
services subscribed to
applications installed
the history of ads recently served

Continuing with the description of the cache management processes, as shown in the figure, when ad content (shown as Ad Bundle 300 in the figure) is received by Ad Module 104 which is executed on client device 108, it is first determined if Ad cache 240 is full or cannot otherwise store the ad content (stage 510 in the figure). If Ad cache 240 is not full, then a “weak” filtering process may be applied (as will be described with reference to “Weak” Filter 520 in the figure).

If present, Weak Filter process 520 is intended to determine if there are reasons not to cache the ad content, even though data storage space may be available. For example, Weak Filter 520 may determine that the ad content is not appropriate for the user of the device (based on user profile data or other filtering characteristics), is not appropriate for the device itself (as a result of characteristics of the device itself), etc. Note that the ad content may itself include data or meta-data that overrides the Weak Filter process.

The output of Weak Filter process 520 is a determination that the ad content in question is either appropriate or not appropriate for the user. If the determination is that it is not appropriate, then the ad content is not cached and is instead deleted or otherwise disposed of (as suggested by the trash icon 530 in the figure). If the determination is that the ad content is appropriate, then the ad content is stored in Ad cache 240 (as suggested by the “Store New Ad” stage 540 in the figure).

As noted, upon receipt of ad content, it is first determined if Ad cache 240 is full or cannot otherwise store the ad content (stage 510 in the figure). If Ad cache 240 is full, then Local Filter 250 implements an intelligent process to determine if the new ad content has sufficient relevance to the user of the client device to justify storing the new ad content in the cache (and delete currently cached items to make room for the new item). This intelligent process may be implemented by Ad Scorer 550. Ad Scorer 550 represents a set of executable instructions, heuristics, algorithms, etc. that implement a process or processes to evaluate whether the new ad content that is proposed for storage in Ad Cache 240 is sufficiently relevant to the user of client device 108 to justify its storage. Although an example of such an evaluation process will be described, it is to be understood that other processes, heuristics, algorithms, etc. may be used to accomplish a similar function and that such other processes and methods are intended to be within the concept of the present invention.

In one form or another, Ad Scorer 550 may compute a relevancy score for the new ad content. The relevancy score may be determined by application of rules, heuristics, or algorithms to the keywords and/or other meta-data provided with the ad content. The user profile, present location, present activities, and/or device characteristics may also be used as part of the scoring process. The intention is to develop a value for a metric that may be used to determine whether to store the ad content based on comparison with the relevancy metric for other currently stored content. In this way an intelligent decision may be made as to whether the new ad content is more or less relevant or potentially relevant to the device user than other current currently stored in the cache.

As an example, a process defined in whole or part by the following steps may be used to determine whether to cache new ad content and evaluate the relevancy score for ad content when such content is received from the network:

1. If there is sufficient free space in the cache to store the new ad:
a. If not over-ridden, apply a weak ad filter process to determine if there is a reason not to store the new ad;
b. If the weak filter determines that the ad should not be stored on this device under any circumstances, discard the new ad;
c. If there is no reason to prevent storing the new ad on this device, store the new ad;
d. Finished.

2. If there is insufficient free space in the cache to store the ad:
a. Determine the amount of cache space that would need to be freed up to make room for this ad by subtracting the current cache free space from the size of the new ad;
b. Score this ad using the ad's keywords and metadata, and the local user's profile information;
c. If this ad has been marked as “must cache” by the server, assign the highest score possible to this ad for use in the comparison operations below;
d. Unmark all ads that are marked for possible deletion;
e. While not finished:
   i. Look up the ad with the lowest score currently in the cache that is not marked for deletion;
   ii. If more than one ad has the same score, use a “tie-breaker” algorithm to determine which ad is of least relevancy to the user of the device, and select that ad for further consideration below;
   iii. If the lowest ad's score is equal to the score of the current ad, use a “tie-breaker” algorithm to determine if the new ad is more or less relevant to the user of the device than the ad selected from the cache;
   iv. If the lowest ad's score is greater than the score of the new ad:
      1. Discard the new ad;
      2. Unmark all ads marked for possible deletion;
      3. Finished.
   v. If the lowest ad's score is less than the score of the new ad:
      1. Mark the lowest ad's score for possible deletion;
      2. If the sum of all the ads in the cache marked for possible deletion is less than the amount of cache space needed to store the new ad, continue with the next lowest scored ad;
      3. If the sum of all the ads in the cache marked for possible deletion is equal to or greater than the amount of cache space needed to store the new ad:
         a. Delete all ads in the cache that are marked for possible deletion;
         b. Store the new ad in the ad cache, along with its score;
         c. Finished.

As indicated, Ad Scorer 550 implements a process to determine the relevancy of the new ad content and also determines which, if any, currently cached ad content should be deleted to make room for the new ad content. Note that if the relevancy score for the new content is less than that for the currently stored content and a “must cache” instruction is not operative, the new content may not end up being cached. In this regard, if the operator, carrier, or other relevant party has issued a “must cache” instruction, the new content will be cached even if that means removing from the cache content with an equal or higher relevancy than the new content. As a result, if a “must cache” instruction is operative or if the relevancy score for the new ad content is greater than that of relevancy score for the ad content having the lowest relevancy score that is currently cached, then the new ad content may be selected for caching (as indicated by stage 560 in the figure). If this is not the case, then the new ad content will not be selected for caching (as suggested by the trash icon 530 in the figure).

If the new ad content has been selected for storage in Ad cache 240, then an item or items of content currently stored in Ad cache 240 may need to be deleted (as indicated by stage 570 in the figure) to provide sufficient room for storage of the new content. The item or items deleted may be selected by identifying the currently stored content having a lower relevancy score than the new content, or by application of one or more “tie-breaking” heuristics or rules, examples of which are given in the following discussion. Note that it may be possible for an ad that scores higher than certain ads in the ad cache to not be cached in cases where the lower scored ads in the cache, if deleted, do not free up enough space in the cache to store the new ad. Based on the algorithm specified above, the new ad would be discarded in such cases.

The following are examples of “tie-breaker” rules, heuristics, or algorithms that may be applied when comparing ad scores that are equal to one another or to determine which content to remove from a cache:
The oldest ad is considered having the lower score of the two;
The largest ad is considered having the lower score of the two;
The ad with the least number of modes is considered having the lower score of the two;
The ad shown the most number of times is considered having the lower score of the two; and
The ad that is set to expire earliest is considered having the lower score of the two.

As an example of how an ad scoring process could be implemented, the following describes certain stages in a process that determines which ad content to cache and present to a number of different client devices.

As an example of an ad filtering and scoring process, assume a population of 40 users, split evenly between a football stadium and a shopping mall. The users consist of an equal number of males, females, those aged 40 years or more, and those aged under 40. The advertiser has ad content they wish to deliver and have presented for sneakers, beer, coffee, sports memorabilia, vitamins, minivans, sports cars, gaming systems, the upcoming hockey season, and clothing. Note that the service provider filter (implemented as part of Ad Server 102) may choose to send ads for beer and the upcoming hockey season only to the football stadium, send the coffee and vitamins ads only to the shopping center, and the remaining ads to both locations. The local device filters may score the ads based on the users in the following manner:

| Ad | Stadium | Mall | M < 40 | M ≧ 40 | F < 40 | F ≧ 40 |
|---|---|---|---|---|---|---|
| Sneakers | √ | √ | 80 | 60 | 70 | 50 |
| Beer | √ | | 100 | 80 | 80 | 50 |
| Coffee | | √ | 75 | 75 | 75 | 75 |
| Memorabilia | √ | √ | 90 | 70 | 50 | 30 |
| Vitamins | | √ | 30 | 80 | 50 | 100 |
| Minivans | √ | √ | 0 | 50 | 80 | 80 |
| Sports Cars | √ | √ | 70 | 90 | 30 | 60 |
| Gaming | √ | √ | 80 | 50 | 50 | 0 |
| Hockey | √ | | 90 | 90 | 30 | 0 |
| Clothing | √ | √ | 70 | 50 | 100 | 80 |

Assuming that the caches size for all devices is 3 ads, and based on the filtering and scoring system shown in the table above, the ads would be placed in the following way:

| User Details | Ad1 (score) | Ad2 (score) | Ad3 (score) |
|---|---|---|---|
| F < 40 @ Stadium | Clothing (100) | Beer (80) | Minivans (80) |
| F > 40 @ Stadium | Minivans (80) | Clothing (80) | Sports Cars |
| | | | (60) |
| F < 40 @ Mall | Clothing (100) | Minivans (80) | Coffee (75) |
| F > 40 @ Mall | Vitamins (100) | Minivans (80) | Clothing (80) |
| M < 40 @ Stadium | Beer (100) | Memorabilia | Hockey (90) |
| | | (90) | |
| M > 40 @ Stadium | Hockey (90) | Sports Cars | Beer (80) |
| | | (90) | |
| M < 40 @ Mall | Memorabilia (90) | Gaming (80) | Sneakers (80) |
| M > 40 @ Mall | Sports Cars (90) | Vitamins (80) | Coffee (75) |

The results of service provider and local device filtering show that each individual in the network would then be the recipient of specifically targeted ads. The example can also be used to show how items in the cache are further refined as part of the cache management process as new ads come in. For example, to accomplish the goal of always having something to show the user, the first three ads received by the device are added to the cache regardless of score, since the cache has empty slots to store those ads. When a fourth ad is received, the score of that ad is compared to the scores of the ads already contained in the now full cache to see if it scores higher than any ad contained therein.

Assume the ads are distributed in the following order, with the scores shown for the female under 40 at the football stadium: sneakers (70), beer (80), sports memorabilia (50), minivans (80), sports cars (30), gaming systems (50), the upcoming hockey season (30), and clothing (100). The first three ads are cached since there is room in the cache to hold those ads regardless of score.

| User Details | Ad1 (score) | Ad2 (score) | Ad3 (score) |
|---|---|---|---|
| F < 40 @ Stadium | Sneakers (70) | Beer (80) | Memorabilia (50) |

### When the fourth ad, minivans (80) is received, the local cache manager compares its score with the lowest scoring ad already in the cache, sports memorabilia (50) and finds that it should be replaced with the minivan (80) ad.

| User Details | Ad1 (score) | Ad2 (score) | Ad3 (score) |
|---|---|---|---|
| F < 40 @ Stadium | Sneakers (70) | Beer (80) | Minivans (80) |

The next three ads received, sports cars (30), gaming systems (50), and the upcoming hockey season (30), do not score high enough to replace any of the existing ads, and are discarded. When the final ad, clothing (100), is received, it does score high enough to replace sneakers (70). This leaves the final cache as follows:

| User Details | Ad1 (score) | Ad2 (score) | Ad3 (score) |
|---|---|---|---|
| F < 40 @ Stadium | Clothing (100) | Beer (80) | Minivans (80) |

Note that the process, heuristic, rules, or algorithm used to score and manage replacement of ads in the cache may be more complex than the example discussed. For example, it is likely that ads will be of different sizes, and take up more or less of the ad cache. When a new ad is being considered for addition to a full cache, more than one ad may need to be removed to make room for the new ad. Thus, the scores of all ads affected need to be taken into consideration. One method of accomplishing this would be to compare the average scores of the ads that would need to be discarded to make room for the new ad, and if the new ad scored higher than that average, the collection of existing ads would be discarded to make room for the new ad.

FIG. 6 is a functional block diagram and associated description illustrating a process by which a locally resident ad content selection policy may be used to select ad content for display in accordance with one embodiment of the present invention. The figure illustrates how an active ad policy executed on a client device interacts with one or more applications executing on the device to select and display ads to the user of the device. For the purposes of the example, two applications are shown as having registered with the device and as being executed, a baseball application 610 and a video game application 620. Applications 610 and 620 represent applications downloaded to or resident on local device 108. Applications 610 and 620 register with Ad Module 104, in part to inform Ad Module 104 when they are capable of receiving ad content (as indicated by stage 650 in the figure). Once registered, the applications are added to the Registered Apps list 660. After registration, ad policy logic 680 which is part of Ad Policy 670, is executed. Ad Policy logic 680 examines the ad display policy and if relevant, application specific data, to determine the frequency and timing of the ad content that will be displayed. As discussed previously, at the appropriate time, application specific event, etc., the ad policy will notify the relevant application that an ad should be displayed. This will typically be implemented by using the “notify” API 260.

Upon receipt of the notification, the relevant application (in this case the baseball application), generates a call to the getAd( ) API 260 (as indicated by stage 690 in the figure). In response, Ad selector module 692 interfaces with Ad Cache 240 to access the cache and retrieve the desired ad content. The selected ad content is then provided to the application for display to the user. As an example, for the baseball application, the application may have a dedicated banner area where ads can be rotated into and out of at any time. Thus, when an ad notification is received, the new ad can be placed immediately into the specified region for display to the user.

Similarly, in the case of a video game or other application, the application may embed ad content into the play area at the end of a specific task or at each level. In this case, when an ad notification is received, the game or application may wait for the appropriate time or event to place ad content.

As a further description of the possible manner in which an ad policy may interact with one or more applications executing on a client device, the following describes the interaction between an active display policy and a baseball application in additional detail:
1. The active display policy specifies that ads are to be shown to the user for a minimum of 2 minutes, up to a maximum of 5 minutes. The ad rotation scheme specifies that all ads in the cache that match the application's keywords are to be used on a round-robin basis;
2. The baseball application registers with the ad module and specifies keywords such as baseball, sports, food, and beer;
3. The ad module starts the active display policy and immediately notifies the baseball application to display an ad;
4. The baseball application requests an ad from the ad module immediately, since it has dedicated screen space available at all times for the display of a banner ad. The baseball application specifies the screen area available for the ad, and that the ad should be a static image. The ad module uses the keywords supplied to locate specific ads in the cache, and presents them on a round-robin basis;
5. The ad module notes the time the ad is delivered to the baseball application for use by the active display policy;
6. After 2 minutes, the active display policy notifies the baseball application to display new ad within the next 3 minutes;
7. Since the baseball application can display new ads at any time, it calls the ad module for the next ad; and
8. The ad rotation scheme continues, with a new ad being displayed every two minutes until the baseball application deregisters with the ad module.

Similarly, the following describes the interaction between an active display policy and an arcade/video game application in greater detail:
1. The active display policy specifies that new ads are to be shown to the user every two to five minutes. The ad rotation scheme specifies that all ads in the cache that match the application's keywords are to be used on a round-robin basis;
2. The arcade game registers with the ad module and specifies keywords such as space, soda, game, and teen;
3. The ad module starts the active display policy and immediately notifies the arcade game to display an ad;
4. The arcade game waits until the user reaches the end of the current level before requesting an ad to display, since the arcade game only has screen space available to display an ad in between levels. The arcade game specifies the screen area available for the ad, and that the ad can be a static image or a video clip. The ad module uses the keywords supplied to locate specific ads in the cache, and presents them on a round-robin basis, giving preference to ads that contain video clips;
5. The ad module notes the time the ad is delivered to the arcade game for use by the active display policy;
6. The user may reach the end of the next game level before two minutes. If so, the arcade game requests a new ad from the ad module since it has an opportunity to display another ad. The ad module notes the time so that the active policy can monitor the frequency of ad delivery;
7. If the arcade game does not request a new ad for more than two minutes, the active display policy notifies the arcade game to display a new ad within the next three minutes;
8. The arcade game needs to wait until the user reaches the end of the level before requesting an ad from the ad module. If more than three minutes elapse before the user reaches the end of the current level, the arcade game suspends game play and requests an ad for display. Since the game is being preempted for an ad, the arcade game tells the ad module that it can display a full screen ad if available; and
9. The ad rotation scheme continues, with a new ad being displayed every two to five minutes until the arcade game deregisters with the ad module.

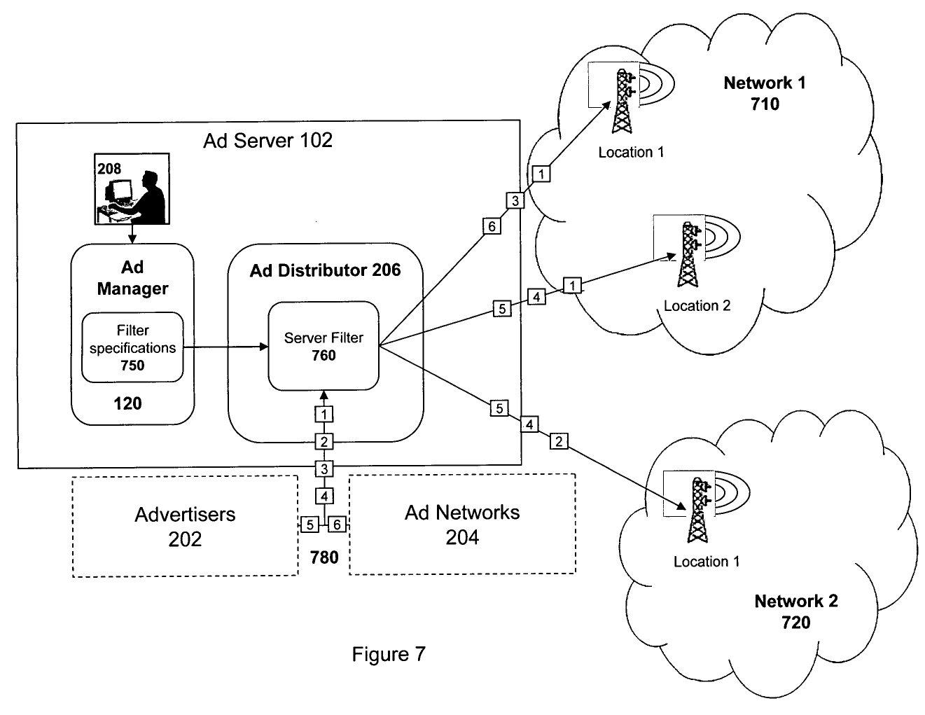

FIG. 7 is a functional block diagram and associated description illustrating the primary functions of a server ad filter in accordance with one embodiment of the present invention. As discussed, ad content filtering may be implemented at several levels of the present invention. In this regard, a local filter executed on the client device was discussed with reference to cache management and FIGS. 2 and 5. In addition, ad content may be filtered at the server level prior to distribution of ad content over a network. Thus, ad content may be filtered both at the service provider and at the local device. For example, the service provider, network operator, ad policy creator, or other party may filter the ad content stream based on information that it has available concerning the user population as a whole. In contrast, the local device may filter ad content based on the specific characteristics of the device, present location, user profile, and/or current activities of the user.

As shown in FIG. 7, ad policy creator 208 or other party may provide Ad Manager 120 with filter specifications 750 to be implemented by server filter 760. The filter specifications 750 may be based on data or user profiles for the user population or on other information available to the policy creator concerning the intended recipients of the ad content (including network or network infrastructure related information). Filter Specifications 750 are provided to Server Filter 760 for implementation of the filtering process. Server Filter 760 utilizes the filtering specifications 750 to filter ad content (represented by boxes 780 in the figure) received from Advertisers 202, Ad Networks 204, or other sources prior to distribution of the ad content 780 to users by transmission over a network (as suggested by Network 1 710 or Network 2 720 in the figure).

As suggested by the different sets of ad content 780 (as indicated by boxes 1, 3, and 6 provided to Location 1 of Network 1, boxes 1, 4, and 5 provided to location 2 of Network 1, etc.) provided to the different networks (elements 710 and 720 in the figure), the filtering process is able to select a set of ad content most appropriate for a particular network, location, or expected user population, among other criteria.

A system and associated apparatus and methods to enable the resource-efficient and cost-effective delivery, selection, and display of ad content to devices has been described. The inventive system, apparatus, and methods include the ability to distribute ad content and ad selection policy independently of each other, thereby enabling the update or revision of ad policy in real-time or pseudo real-time to implement changes to the policy in view of current events, emergencies, sporting events, and/or other events.

The inventive system utilizes a broadcast mode of data transfer to provide cost-effective and network resource and infrastructure efficient delivery of data. The inventive system also includes intelligent cache management processes for the determination of what ad content to retain in a local device cache in the event that the cache is not able to store all ad content available to it. Further, the inventive system is capable of collecting and processing tracking data to indicate how ad content was used by the local device, and how a user responded to that ad content. Such content usage data may be utilized in modifying ad policy, determining cache contents, or in determining ad revenue streams or other business models.

The combination of a flexible and real-time updatable ad selection policy and intelligent cache management process provides many benefits in terms of the effective delivery of ad content. For example, the delivery of ad content can be controlled to provide highly relevant ad content to a group of users based on multiple parameters, and the delivery model can be altered on a relatively short timescale.

In this regard, the following examples are intended to suggest how the inventive ad cache management processes and ad display policies may work together to provide a powerful and flexible way to target ads to individual users in a large population:

1. Proposed strategy for fast food restaurants
A global ad filter (e.g., server filter) that sends ads for various restaurants to different geographic areas based on where the restaurants are located
   A-Burger restaurants are located in only 16 states in the U.S., so ads for A-Burger are only broadcast to devices located in those states
   BurgerWorld is a worldwide chain, so its ads are distributed everywhere
A local ad filter (e.g., device level filter) that stores only the ads for users that eat out at fast food restaurants
   The device may know something about the eating habits of the user. If the user would generally not eat at a fast-food chain, ads for fast-food chains are not cached since they would be of no interest to the user.
A policy to display ads describing breakfast selections only early in the morning
   The BurgerWorld breakfast sandwich, a breakfast entree, is only displayed between 4:00 AM and 10:00 AM since the sandwich is not available for sale after 11:00 AM
A policy to favor the display of ads for restaurants within 1 mile of the device, based on its current GPS location
   If the user is located within 1 mile of an A-Burger, that ad is selected over a BurgerWorld ad
A policy to display ads containing daily promotions only on the day of the promotion
   BurgerWorld is running a special Tuesday's for the BigBurger meal. The ad promoting the special is only shown Monday night and all day Tuesday
A policy to give preference to restaurants that have the current highest bid, which can be updated and distributed to the user population as bids change
   The user is located within 1 mile of both a BurgerWorld and an A-Burger. If A-Burger offers to pay more per ad than BurgerWorld, the A-Burger ad is selected over the BurgerWorld ad.
      If BurgerWorld chooses to outbid A-Burger for ad placement, a new display policy favoring BurgerWorld can be built and distributed in real-time to all devices such that they will choose to display an ad for BurgerWorld over an A-Burger ad when both ads are appropriate for display to the user.
A policy to show ads for a particular restaurant late at night only for restaurants that are open late
   A-Burger closes at 11:00 PM, so they prefer not show pay for ads shown after 11:00 PM and before 5:00 AM, when their restaurants reopen. BurgerWorld is open until 1:00 AM, so between 11:00 PM and 1:00 AM, only BurgerWorld ads are shown.
A policy to examine the click-through rate on a specific ad and choosing to stop showing that ad if the click-through rate is too low
   BurgerWorld is trying a new marketing campaign targeted at women. To better determine the effectiveness of the new campaign, BurgerWorld wants to show the new ads 50% of the time to women, and show the general ad the other 50% of the time.
      When ad response and usage data is collected concerning the number of ads shown to the user population and the click-through rate, BurgerWorld may see that the click-through rate for those ads is lower than their general marketing campaign ads when shown to women under the age of 25. BurgerWorld may decide that the new ad is not effective for that demographic group and update the display policy to stop showing that ad to women under the age of 25. The new display policy may be updated at the server and distributed to the user population.

2. Proposed strategy for television show trailers
A global ad filter that sends ads to different markets based on the channels/networks available in those markets
   The F network is only available in certain markets in the U.S. Ads for television shows broadcast on the F network are only distributed to areas of the country where the F network channels are available.
A local ad filter that loads ads for cartoons only for those under age 14
   Ads for Squirrley Squirrel get cached only on devices where the age of the user is under 14 years of age.
A local ad filter that loads ads for reality television shows for those over age 18
   Ads for The Loser are cached only on devices where the age of the user is 18 years or older
A local ad filter that loads ads for daytime talk shows for those at home
   Ads for The Inside Scoop are only cached on devices where the profile of the user indicates that the user does not work during the day.
A local ad filter that loads ads for comedies only for those aged under 45
   Ads for situation comedies are cached only at devices where the age of the user if 45 or over
A policy to display ads more frequently for shows that are about to air
   Ads for a show are shown more frequently for the 3 hours just preceding the show's broadcast time than at other times.
A policy to display ads based on the user's viewing history
   This user has watched reality television predominantly over the last month. The display policy indicates that such a user should see more ads for shows that are reality-based than other types of shows, and more specifically, reality-based shows that the user has not tuned into yet.
A policy to prevent the display of ads for shows that aren't scheduled for broadcast for more than 3 days
   The hit show Tuesday Tonight is broadcast Tuesday evenings. Ads for the show are shown only Sunday through Tuesday evening. Ads are not shown Wednesday through Saturday.
A policy to show ads for a specific network when the user is changing channel to or from that network
   An Electronic Service Guide (ESG) application may inform the ad module as to what channel the user is changing from and to. For example, the user may be changing the channel from the F network to the A network.
   The display policy can specify that if the user is changing away from the F network, then display an ad for their exciting new show, in an attempt to persuade that user to come back to the F network channel
      The display policy may even be more specific, indicating that this rule is only for males, or females under the age of 30, and that females over the age of 30 get the commercial for another, presumably more appropriate show.

As discussed, the ad module executing on each client device may be responsible for ad cache management. This eliminates the need for each application running on the device to perform such management functions itself, and provides predictable, secure control of the cache to the service provider or network operator.

As recognized by the inventors, once targeted ads are present in the cache, applications need a method by which to obtain ads to display to the user. The service provider, network operator, etc. needs to be able to control the mechanism by which those ads are selected and displayed to a user. The service provider, etc. can not be involved each time an application needs to display an ad over the entire population of users in the network. This is because doing so would congest the network, delay delivering ads to the applications, and reduce the benefits of having an ad cache. In addition, real-time control over the selection and display of ads can be of value to the service provider, etc. This problem can be solved by implementing an ad policy delivery system that enables the policy or policy updates to be distributed in real-time to the entire network population or relevant portion thereof.

The ad policy can contain complex instructions, which may be effective for long periods of time, and require infrequent updates. In this case the ad policy can specify different algorithms for different days, or even different times of the day. For example, if the ad policy is generally broadcast once a week, the policy may have certain rules for weekdays and other rules for weekends. If the policy is generally provided once a day, the policy may contain a set of rules for the morning, a different set of rules for the afternoon, and another set of rules for the evening. The ad policy used to select which ad to present to the user from the ad cache can specify an ad rotation scheme or indicate which ads are relevant for particular times of day. The policy can also take into account device dependent data such as user profile, the capabilities of the device, and location of the device. Applications may optionally choose to provide additional context information to the ad module which can be used to supplement the selection process for the ads.

As mentioned, ad policies can be overridden or supplemented during periods or at times when a new, short-term policy is required. For example, at the half-time of a football game, the ad aggregator, etc. may want to show one set of ads instead of another based on the score of the game. Since the score of the game is not known when the ads are cached, or when the primary display policy is distributed, an override policy can be distributed at half time that takes into account the score of the game. Once the short-term period is over, the regular policy may go back into effect.

Further, there may be multiple relationships and interactions between the ad cache and ad policy. The ad cache may be relatively fixed, and a changing ad policy may cause different ads to be selected over time. Similarly, the ad policy may remain fixed while the ad cache changes over time. In addition, both the ad policy and cache may change over time to provide a greater range of functions. Note that changes in the policy do not necessitate refreshing or reloading the ad cache, which can be slow, expensive or network resource intensive.

The ad display and usage statistics can be collected and provided to the service provider on a scheduled basis, or upon request. As noted, ad usage statistics can be used by the service provider for billing and pricing purposes, but may also be used to further refine the ad cache management process or the policies distributed to the user population. The statistics may also be used to support a bidding system for advertisers. In this situation and without needing to repopulate the cache, a policy change may be quickly distributed throughout the network so that an advertiser that outbid another can increase the number of ad displays that their products receive, or the prominence or circumstances under which the ads are displayed.

Among other advantages of the present invention, ad content distribution occurs without the need for devices in the network to initiate a point-to-point communication with an ad server. This is important in a mobile broadcast environment, but also may be applicable and of value in an environment where the server and/or network can not easily handle requests from all devices (or a sufficiently large number) in the network. Though the server may perform a filtering process to choose which ads to distribute, the local devices filter ads to select those that are most relevant for the user of the device. Additionally, the ad cache has a refinement mechanism so that when the cache is full or nearly full, it may replace ads currently in the cache if a new ad is better suited to the user. Another benefit of the cache management and refinement mechanism is that there is a better chance one or more ads will be available for display when the ad cache is being populated since the cache will generally take ads that are not blocked while the cache has room to store them. Thus, if there is room in the cache, an ad will be stored even if it doesn't score high on the specific user's relevance metrics, as long as that ad isn't inappropriate for that user.

As noted, an important aspect of the present invention is that a server maintains and controls the distribution of an ad display policy which controls which ads get displayed at each device. The policy can be distributed real-time to the devices when the policy changes. The ad policy itself is considerably smaller in size than most ads that have previously been cached, making it easier and more resource conserving to distribute to the device population. This is particularly useful in a mobile broadcast environment where the ad policy can be broadcast over the network with little expense and received by all devices listening on that network.

Other advantages of the invention include that it provides an ad module that serves multiple applications on the local client device. This reduces the amount of logic each application needs to implement, since ad cache management, ad policy execution, and reporting metrics are handled by the ad module. This also gives the service provider or other party a trusted mechanism to ensure ads are displayed according to the provider's specifications.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

1. A system for the distribution and display of advertising content to a device, comprising:
an advertising server configured to communicate with a data distribution network, the advertising server including:
an advertising policy module configured to create and manage the distribution of an advertising policy, the advertising policy controlling the selection of the advertising content for display to a user of the device;
an advertising manager module configured to control the distribution of the advertising content to the user of the device; and
an advertising content usage module configured to obtain and process advertising content usage data from the device; and
an advertising module resident on the device and configured to communicate with the data distribution network, the advertising module including
an advertising cache for storage of the advertising content;
an advertising cache management module for managing the storage of the advertising content in the advertising cache;
a display policy management module for managing and executing the policy used to select and display advertising content;
an interface configured to allow an application capable of executing on the device to interact with the advertising module in order to obtain advertising content stored in the cache for display to the user of the device; and
an advertising content usage data module configured to provide data regarding the display and usage of the advertising content to the advertising content usage module of the advertising server
wherein the system operates to distribute the advertising content and advertising policy separately to the device over the data distribution network by broadcasting the advertising content and advertising policy data to the device.

2. The system of claim 1, wherein the data distribution network is a wireless communications network.

3. The system of claim 1, wherein the data distribution network is a wired communications network.

4. The system of claim 1, wherein the device is a mobile phone, PDA, automated teller machine, ticket vending machine, navigation system, informational kiosk, vending machine, or a wirelessly connected computing device.

5. The system of claim 1, wherein the advertising content usage data module is configured to provide data including the advertising content displayed and actions taken by the user in response to the display of the advertising content.

6. The system of claim 1, wherein the advertising cache management module is configured to implement a process to assess the relevancy of the advertising content to the user of the device prior to determining whether or not to store the advertising content in the advertising cache.

7. The system of claim 1, wherein the interface further comprises:
an interface to permit the application to register with the advertising module;
an interface to permit the advertising module to notify the application when advertising content should be displayed; and
an interface to permit the application to access advertising content stored in the advertising cache.

8. The system of claim 1, wherein the advertising content data further comprises:
a plurality of advertising content data types, each of the plurality representing a different mode or format of data.

9. The system of claim 1, wherein the advertising server further comprises:
a filter configured to filter the advertising content prior to providing the content to the data distribution network.

10. The system of claim 1, wherein the advertising module further comprises:
a filter configured to filter the advertising content received from the data distribution network prior to providing the data to the advertising cache management module.

11. A method of distributing advertising content data to a plurality of devices, comprising:
broadcasting the advertising content data over a communications network;
broadcasting advertising policy data over the communications network, the advertising policy data controlling the selection of the advertising content data for display to a user of each of the devices, wherein the advertising content data and advertising policy data are broadcast separately from each other;
wherein for each of the plurality of devices, the method further comprises:
receiving the advertising content and advertising policy data;
storing the advertising content data in an advertising cache;
registering an application capable of executing on the device;
notifying the application to display advertising content to a user of the device, the notification generated in accordance with the advertising policy data;
accessing the advertising cache to obtain the advertising content to display to the user of the device; and
displaying the accessed advertising content to the user of the device.

12. The system of claim 11, wherein the communications network is a wireless communications network.

13. The system of claim 11, wherein the communications network is a wired communications network.

14. The method of claim 11, further comprising:
broadcasting updated advertising policy data over the communications network,
wherein for each of the plurality of devices, the method further comprises:
receiving the updated advertising policy data; and
implementing the updated advertising policy data to control the selection and display of the advertising content data stored in the advertising cache in accordance with the updated advertising policy data.

15. The method of claim 11, further comprising:
implementing an advertising cache management process, wherein the process assesses the relevancy of the advertising content data to the user of the device prior to determining whether or not to store the advertising content data in the advertising cache.

16. The method of claim 11, wherein the application, without notification by the ad module, accesses the cache to obtain an advertisement to be displayed.

17. The method of claim 11, further comprising:
collecting data regarding the display and usage of the advertising content data on the device and providing that data to a server over the communications network.

18. The method of claim 17, wherein the collected data includes data regarding actions taken by the user of the device in response to display of the advertising content data.

19. The method of claim 11 wherein the advertising content data further comprises a plurality of advertising content data types, each of the plurality representing a different mode or format of data.

20. The method of claim 11, wherein each of the plurality of devices is a mobile phone, PDA, automated teller machine, ticket vending machine, navigation system, informational kiosk, vending machine, or a wirelessly connected computing device.

21. A device for displaying advertising content data, comprising;
a process executing on the device to receive the advertising content data from a communications network;
a process executing on the device to receive advertising policy data from a communications network, the advertising policy data acting to control the selection of advertising content data for display to a user of the device, the advertising content data and advertising policy data being broadcast separately over the communications network to the device; and
a process executing on the device to control storage of the received advertising content data in a device cache, the process configured to assess the relevancy of the advertising content data to the user of the device prior to determining whether or not to store the advertising content data in the advertising cache.

22. The device of claim 21, further comprising:
a process executing on the device to receive updated advertising policy data broadcast over the communications network, and in response to implement the updated advertising policy data instead of the previously received advertising policy data.

23. The device of claim 21, further comprising:
a process executing on the device to collect data regarding the display and usage of the advertising content data on the device and provide that data to a server over the communications network.

24. The device of claim 23, wherein the collected data includes data regarding actions taken by the user of the device in response to display of the advertising content data.

25. The device of claim 21, wherein the device is a mobile phone, PDA, automated teller machine, ticket vending machine, navigation system, informational kiosk, vending machine, or a wirelessly connected computing device
